(19) United States
(12) Patent Application Publication
(10) Pub. No.: US 2002/0147000 A1
(43) Pub. Date: Oct. 10, 2002

(54) System and method for real-time addition of devices to a subscriber account

(76) Inventor: David A. Holmes-Kinsella, San Francisco, CA (US)

Correspondence Address: CARR & FERRELL LLP, 2225 EAST BAYSHORE ROAD, SUITE 200, PALO ALTO, CA, 94303, US

(21) Appl. No.: 09/826,442

(22) Filed: Apr. 4, 2001

(51) Int. Cl. H04M 11/00

(52) U.S. Cl. 455/405; 455/406

(57) ABSTRACT

A system and method for real-time addition of devices to a subscriber account creates the subscriber account with a service provider, associates a first device with the subscriber account, connects to the service provider using a second device, determines that the second device is not associated with the subscriber account, and associates the second device with the subscriber account. The service provider may determine that the second device does not match the subscriber account by comparing a device identifier of the second device with a database of account information. The service provider may associate the second device with the subscriber account by adding the device identifier of the second device to a list of valid device identifiers for the subscriber account. The devices are preferably mobile communication devices such as mobile telephones and personal digital assistants.

### BACKGROUND OF THE INVENTION

1. Field of the Invention

This invention relates generally to subscription services and more particularly to real-time addition of devices to a subscriber account.

2. Description of the Background Art

Mobile telephones and other wireless communication devices are becoming increasingly popular. Besides basic person-to-person communication, mobile communication devices can provide consumers with an increasingly wide range of services. For example, a user of a mobile phone may connect to a service that provides information such as weather, directory assistance, news, and sports scores.

Some of these services provide personalized information, such as stock prices, horoscopes, and reports of local traffic conditions. To provide personalized services, a user's telephone or other mobile device must be registered with the service provider. The user typically connects his or her telephone or other device to the service provider. The service provider compares the device's identifier to an account database. The service provider then accesses the particular personalized information for that user.

This kind of personalized service can be very convenient for users; however, typically only one communication device per subscriber account is registered with the service provider. Some service providers allow users to register more than one device to a subscriber account, but typically require a user to register the multiple devices when initially setting up the account.

Requiring multiple devices to be registered at the same time can be inconvenient to users. For example, a user may initially register a mobile telephone with the service. At a later time, the user may acquire a personal digital assistant (PDA) device that is also able to access the service provider. Typically the user will have to use a different means, perhaps a web site, to contact the service provider to establish a new account for the new device.

### SUMMARY OF THE INVENTION

A method for real-time addition of devices to a subscriber account includes creating the subscriber account with a service provider, associating a first device with the subscriber account, using a second device to connect to the service provider, determining that the second device is not associated with the subscriber account, and associating the second device with the subscriber account.

The service provider may determine that the second device does not match the subscriber account by comparing a device identifier of the second device with a database of account information, including a list of valid device identifiers. The service provider may associate the second device with the subscriber account by adding the device identifier of the second device to a list of valid device identifiers for the subscriber account.

The service provider typically provides information services, and preferably individualized information services, to subscribers. When establishing a subscriber account, a user may indicate preferences for the types of information desired.

The devices are preferably mobile communication devices such as mobile telephones and personal digital assistants; however, associating a subscriber account with any type of communication device is within the scope of the present invention.

### BRIEF DESCRIPTION OF THE DRAWINGS

FIG. 1 is a diagram of one embodiment of an electronic communication system in accordance with the invention;

FIG. 2 is a diagram of one embodiment of a mobile communication device in accordance with the invention; and

FIG. 3 is a flowchart of method steps for real-time addition of devices to a subscriber account, in accordance with one embodiment of the invention.

### DETAILED DESCRIPTION OF THE PREFERRED EMBODIMENT

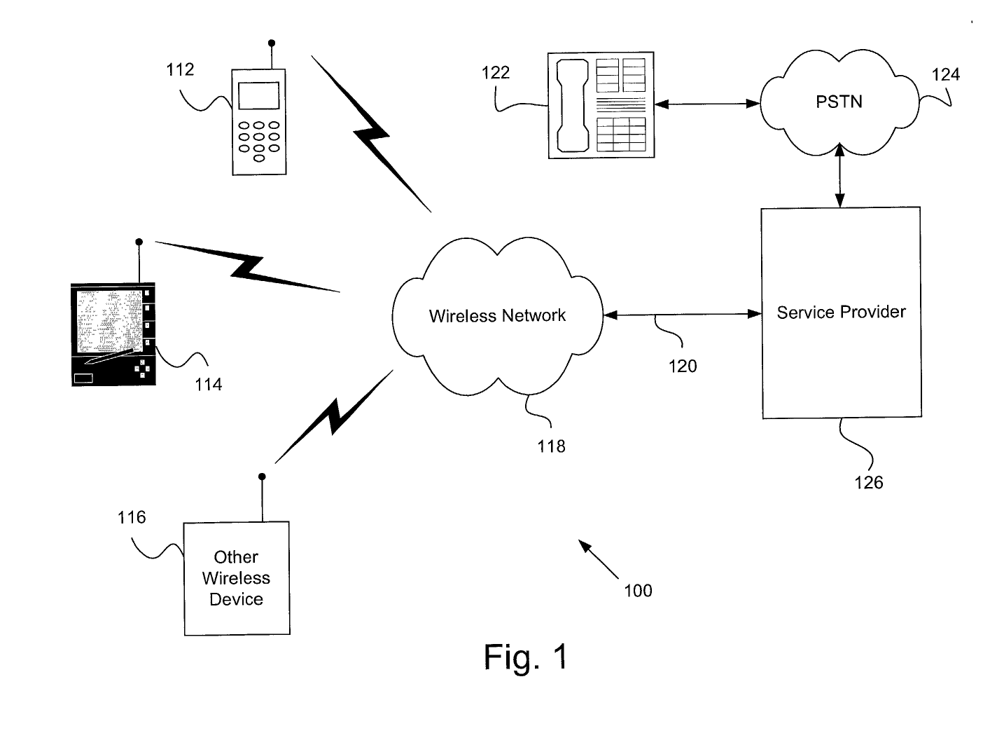

FIG. 1 is a diagram of one embodiment of an electronic communication system 100 according to the invention. System 100 includes, but is not limited to, a mobile telephone 112, a personal digital assistant (PDA) 114, another wireless device 116, a wireless network 118, a telephone 122, a Public Switched Telephone Network (PSTN) 124, and a service provider 126. Telephone 112, PDA 114, and the other wireless device 116 communicate via wireless network 118 and path 120 with service provider 126. The mobile communication devices in FIG. 1 may communicate with service provider 126 using any appropriate wireless communication methodology. Telephone 122 communicates with service provider 126 using Plain Old Telephone Service (POTS). A user may use telephone 122 to connect to service provider 126 to utilize the offered services or to communicate with a human agent, for example a customer service representative.

In the FIG. 1 embodiment, service provider 126 may provide general information, such as directory assistance and news reporting, to any user. Service provider 126 also preferably provides individualized services, such as sports scores, stock quotes, horoscopes, traffic reports, and weather reports, to subscribers. Service provider 126 may act as a proxy for other information providers, such as news wire services, may generate information itself, or provide a combination of proxied and self-generated information. In other embodiments, service provider 126 may provide any services for which a user may establish an account. A subscriber is a user who has established an account with service provider 126, and has preferably provided personal information and preferences as to the type of services desired.

A subscriber using a communication device, such as mobile telephone 112, connects to service provider 126 to access desired information. Service provider 126 may identify the subscriber by the device's Automatic Number Identification (ANI), Calling Line Identifier (CLI), or other device identifier. Service provider 126 typically requires the subscriber to enter a password to access the individualized services, although in some embodiments a password is not required. Service provider 126 compares the device identifier and password with its account records to validate the transaction. The service provider's account records for each account will contain an account identification, for example the subscriber's name, a password, and the device identifiers associated with the account.

If the device identifier and password match its account records, service provider 126 then retrieves information according to the preferences associated with the subscriber's device identifier. The subscriber may choose to receive some or all of the information associated with his or her account. The subscriber may interact with service provider 126 in a variety of ways, for example vocal commands, keystrokes, or a graphical user interface.

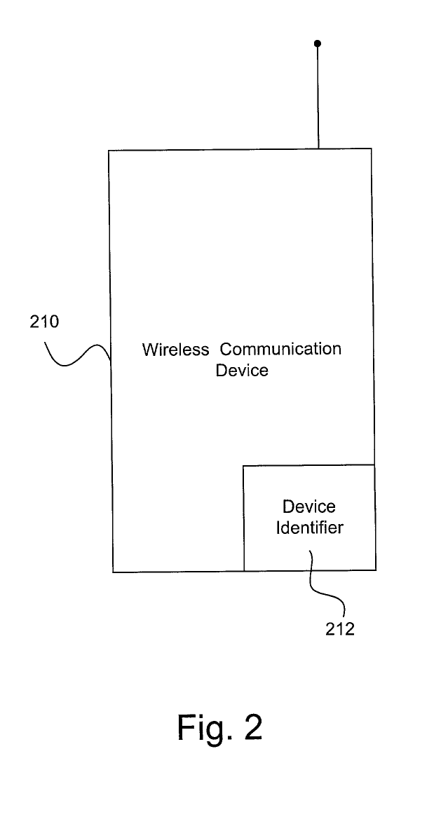

FIG. 2 is a diagram of one embodiment of a mobile communication device 210 in accordance with the invention. Mobile communication device 210 may be a mobile telephone, PDA, or other type of mobile device. A device identifier 212 uniquely identifies device 210. Device identifier 212 may be an Automatic Number Identification (ANI), a Calling Line Identifier (CLI), serial number, or other number or code that is applied to device 210. Device identifier 212 may also be an IP address or E-mail address. Device identifier 212 typically provides no information regarding the location or owner of device 210.

Device identifier 212 is not equivalent to a “cookie,” i.e., a small piece of data that may be stored on a user's computer or other device when the user accesses a web site. Device identifier 212 is permanently associated with a particular device, and is not associated with a particular service provider or a web site.

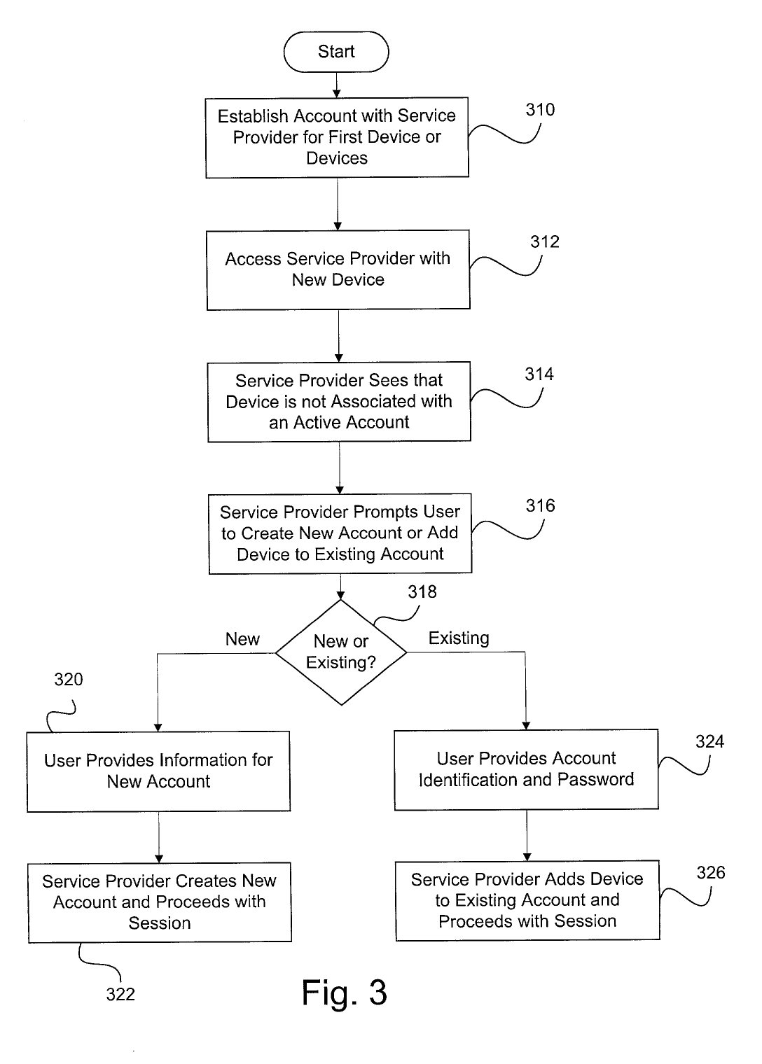

FIG. 3 is a flowchart of method steps for real-time addition of devices to a subscriber account, in accordance with one embodiment of the invention. First, in optional step 310, a user establishes an account with service provider 126 for a first device or multiple devices. The user may establish the account via a web site, a PSTN connection, or any other methodology supported by service provider 126. The account information includes a device identifier for each device, and an account identification and a password for the account. The account information may be stored in an account database. The user, now a subscriber, may also indicate preferences as to which types of information are desired.

Then, in step 312, the user accesses service provider 126 with a new device, for example mobile telephone 112. In step 314, service provider 126 recognized by the device identifier that the new device is not associated with an active account. That is, service provider 126 checks the new device's device identifier against its account database and does not find a match.

In step 316, service provider 126 prompts the user to either create a new account or to add this new device to an existing account. In step 318, the user determines whether to create a new account or to add this new device to an existing account. If the user has an existing account with service provider 126, the user may choose to create a new account for the new device, where for example the new device will be associated with a business account.

If the user chooses to create a new account, the method continues with step 320, where the user provides the information including a password required to establish a new account with service provider 126. Then, in step 322, service provider 126 creates the new account and associates the device identifier of the new device and the password with the account.

If the user chooses to add the new device to an existing account, then the method continues with step 324, where the user provides the account identification and password to service provider 126. The account identification may be an account number, the user's name, or other identification. The password may be a group of numbers, letters, symbols, or a combination thereof. The method continues with step 326, where service provider 126 adds the new device to the user's existing account, and then proceeds with the session.

The invention has been explained above with reference to a preferred embodiment. Other embodiments will be apparent to those skilled in the art in light of this disclosure. For example, the present invention may readily be implemented using configurations other than those described in the preferred embodiment above. Additionally, the present invention may effectively be used in conjunction with systems other than the one described above as the preferred embodiment. Therefore, these and other variations upon the preferred embodiments are intended to be covered by the present invention, which is limited only by the appended claims.

What is claimed is:

1. A method for adding a device to a subscriber account, comprising the steps of:
creating the subscriber account with a service provider;
associating a device with the subscriber account;
connecting to the service provider using a second device;
determining that the second device is not associated with the subscriber account; and
associating the second device with the subscriber account.

2. The method of claim 1, wherein the step of associating a device includes associating with the subscriber account a device identifier of the device.

3. The method of claim 2, wherein the step of determining that the second device is not associated includes comparing a device identifier of the second device with a database including device identifiers associated with subscriber accounts.

4. The method of claim 3, wherein the device identifier is an Automatic Number Identification (ANI) or a Calling Line Identifier (CLI).

5. The method of claim 1, further comprising the step of providing an account identifier to the service provider to identify the subscriber account.

6. The method of claim 1, wherein the device is a mobile telephone.

7. The method of claim 1, wherein the second device is a mobile telephone.

8. The method of claim 1, wherein the device is a personal digital assistant.

9. The method of claim 1, wherein the second device is a personal digital assistant.

10. A system for real-time addition of devices to a subscriber account, comprising:
a service provider configured to provide information services and to store the subscriber account;
a first device associated with the subscriber account; and
a second device initially not associated with the subscriber account;
wherein the service provider recognizes that the second device is not associated with the subscriber account and then associates the second device with the subscriber account.

11. The system of claim 10, wherein the first device is a mobile communication device.

12. The system of claim 10, wherein the first device is a mobile telephone.

13. The system of claim 10, wherein the first device is a personal digital assistant.

14. The system of claim 10, wherein the second device is a mobile communication device.

15. The system of claim 10, wherein the second device is a mobile telephone.

16. The system of claim 10, wherein the second device is a personal digital assistant.

17. The system of claim 10, wherein the service provider determines that the second device is not associated with the subscriber account by comparing a device identifier of the second device with a database including device identifiers associated with subscriber accounts.

18. The system of claim 17, wherein the device identifier of the second device is an Automatic Number Identification (ANI) or a Calling Line Identifier (CLI).

19. A method for real-time addition of devices to a subscriber account, comprising the steps of:
establishing the subscriber account with a service provider;
associating a first device with the subscriber account by having the service provider store a device identifier of the first device in a database;
connecting to the service provider using a second device;
determining that the second device is not associated with the subscriber account by comparing a device identifier of the second device with identifiers stored in the database; and
associating the second device with the subscriber account.

20. The method of claim 19, further comprising the step of providing requested information services to the second device.

21. The method of claim 19, wherein the step of establishing the subscriber account includes specifying preferences for certain information services and associating the preferences with the subscriber account.

22. The method of claim 21, further comprising the step of providing information services to the second device according to the preferences.

23. The method of claim 19, wherein the step of associating the second device includes adding the device identifier of the second device to the database.
